(19) United States
(12) Patent Application Publication
(10) Pub. No.: US 2002/0038193 A1
(43) Pub. Date: Mar. 28, 2002

(54) Measurement of the load status of a motor vehicle

(76) Inventors: Heiko Grunberg, Burgdorf (DE); Klaus-Heiner Hartmann, Neustadt (DE); Carsten Massmann, Hannover (DE); Reinhard Stahmer, Hannover (DE)

Correspondence Address: SMITH, GAMBRELL & RUSSELL, LLP, SUITE 800, 1850 M STREET, N.W., WASHINGTON, DC, 20036, US

(21) Appl. No.: 09/884,106

(22) Filed: Jun. 20, 2001

(30) Foreign Application Priority Data
Jun. 20, 2000 (DE) 100 29 332.8

(51) Int. Cl. B61F 1/14; G06F 7/00

(52) U.S. Cl. 702/173; 701/37; 701/39

(57) ABSTRACT

In order to rapidly and inexpensively deliver information regarding the load status of a motor vehicle, in particular, a utility vehicle with at least one axle that is suspended on pneumatic springs, there is arranged a sensor for measuring the bellows pressure and one additional sensor for measuring the spring travel on each of the pneumatic springs used in the wheel suspensions of the motor vehicle, and to additionally process the pressure and the spring travel in an electronic control unit. In this case, the spring forces preferably are calculated and displayed first, whereafter the wheel forces and ulitmately the position of the center of gravity, as well as the total weight and/or the weight of the net load, are calculated and displayed. The information regarding the load status preferably is also utilized as an input quantity for other safety systems, e.g., for lowering a lift axle, for issuing a warning and/or for throttling the speed in accordance with the respective requirements. This information can also be evaluated for documenting a motor vehicle load and/or an accident.

### INTRODUCTION AND BACKGROUND

The present invention relates to a method and apparatus for delivering information regarding the load status of a motor vehicle. More particularly, the present invention relates to a device for measuring the force transmitted by a pneumatic spring of a vehicle. The present invention has particular applicability to utility vehicles.

The term “load status” not only describes the actual total weight of a motor vehicle, but also the distribution of the total weight over the different axles and their wheels. For example, the actual total weight may lie below the maximum permissible total weight while individual wheels or one individual wheel may be overloaded due to an unfavorable load distribution. This type of load status results in a deterioration of the operating safety of the concerned motor vehicle for the following reasons:

1. the stopping distance is increased due to the uneven load

2. a yawing moment about the vertical axis is created when braking toward the side that lies opposite the overloaded side; this results in deterioration of the directional stability

3. the rolling and tilting stability is reduced toward the overloaded side

4. the probability of tire trouble, failure of a wheel bearing and glazing of the brake lining due to overheating is increased on the overloaded wheel.

In addition, the service life of roads is reduced if the individual axles of a motor vehicle are subjected to uneven loads. This is the reason why most countries not only prescribe the respective permissible total weight for motor vehicles, but also the respective permissible axial load. For example, an axle load of no more than 9.5 t is stipulated for the rear axle(s) of utility vehicles in Germany if the respective axle is suspended on leaf springs; the same axle may be subjected to a load of 11.5 t if it is recognized to be “road-friendly;” however, such a recognition can only be achieved with a pneumatic suspension.

According to a recent investigation by the German Federal Ministry for Traffic, the rear axles of utility vehicles, in particular, of semitrailer towing vehicles, are overloaded in 30% of the checked instances, i.e., these rear axles are subjected to a load in excess of the generous limit of 11.5 t. It was also frequently observed that the other axles of the same utility vehicle or articulated road train are not loaded to capacity. The monitoring of the maximum permissible axle load or the maximum permissible wheel load is unpopular because it is costly and time-consuming. In addition, scales are only available at a few locations and usually so soft that a measurement of the axle load or the wheel load is relatively difficult due to the static overrigidity.

The previously described risks, as well as the contradictory economic interests, are particularly high in utility vehicles, in which

the fluctuations between no-load driving and loaded driving are particularly significant,

the weight indication of a load is particularly unreliable

because the driver does not perform the loading process and

the loading party is interested in indicating a low weight for calculating the freight rates

the center of gravity lies high in relation to the wheel gauge such that the rolling stability and, in particular, the tilting stability becomes lower than in most passenger cars

the available coefficient of friction is usually lower than in passenger cars due to higher air pressure and the correspondingly increased surface pressure.

Utility vehicles, motor trucks, as well as buses, trailers, semitrailer towing vehicles, semitrailers and special vehicles, e.g., emergency medical service vehicles and fire engines are frequently equipped with pneumatic springs on one or more axles or even all axles. In passenger cars, the percentage of pneumatic suspensions is still relatively low, but increasing steadily.

It is an object of the invention to make available a device for motor vehicles equipped with pneumatic suspensions which is also referred to as a “system” below and delivers information regarding the load status in a reliable, fast and inexpensive manner.

It is a further object of the invention to be able to document the load status of the vehicle in order to provide evidence in case of damage or accidents.

Another object of the invention is to be able to acquire information while driving.

### SUMMARY OF THE INVENTION

The above and other objects can be achieved by a device for measuring the force transmitted by a pneumatic spring, which includes a sensor for measuring the respective bellows pressure (p) arranged within the pneumatic spring, one additional sensor (E) for measuring the spring travel (e) arranged in or in the vicinity of the pneumatic spring, an electronic control unit (ECU), into which (ECU) the data regarding the bellows pressure (p) and the spring travel (e) are input, and in which (ECU) a function is stored which describes the effective cross-sectional surface (A) of the pneumatic spring depending on the spring travel (e) of the respective pneumatic spring.

The device then calculates the force transmitted by the pneumatic spring exclusively from these data.

One essential element of the device of the invention is the arrangement of a sensor for determining the bellows pressure and the arrangement of one additional sensor for determining the spring travel on each of the pneumatic springs used in the wheel suspensions of the motor vehicle. The pressure and the spring travel in the pneumatic springs are additionally processed by an electronic computer that is also referred to in the jargon of a person skilled in the art as an “ECU” (Electronic Control Unit) below.

Although the correlation between the pressure and the force occurring in the pneumatic spring is strictly monotonous, it is not linear because the surface, upon which the pressure acts, fluctuates depending on the spring travel due to the construction. However, the invention still makes it possible—after measuring the pressure and the spring travel—to determine the effective spring force on-line from these data.

However, this makes it necessary to initially determine a mathematical function and to store this mathematical function in the ECU. This function describes the effective surface depending on the spring travel for a certain spring-type—analogous to a calibration curve. If the spring travel is input into the ECU after these preparations, the actual cross-sectional surface is known and the force transmitted by the pneumatic spring can be determined together with the additional input pressure. This can be expressed in a formula as shown below:

F=p·A(e)

with “F” representing the force to be calculated, “p” representing the measured air pressure in the pneumatic spring and “A” representing the effective cross-sectional surface in the pneumatic spring depending on the spring travel “e.” The force exerted by each pneumatic spring is determined in the ECU in this fashion.

Since the load fluctuations on the front axle are usually much less significant than those on the rear axle and since the absolute load carrying ability of the front axle usually is also lower than that of the rear axle or the rear axles, the front axles of utility vehicles are frequently equipped with a less expensive leaf spring suspension rather than a pneumatic suspension. However, the effective spring forces of this axle also need to be determined in order to calculate the load status of the motor vehicle. This may be conventionally attained, e.g., by arranging wire strain gauges on both leaf springs, in the form of an electric voltage measurement on a piezocrystalline layer that is arranged between the leaf spring and the axles body or between the leaf spring and the spring receptacle on the frame, or by measuring the spring travel if the stiffness (or “spring constant”) of the leaf spring in question is known. Possibly overloaded wheels can be indicated with such a force measurement on the pneumatic springs and, if applicable, on the leaf springs. It is preferred that at least one additional safety system be activated in case of a wheel overload.

If the motor vehicle is equipped with a lift axle and this lift axle is lifted and the detected wheel overload occurs in the vicinity of the lift axle, the safety system could respond by lowering the lift axle, i.e., by also utilizing the lift axle for carrying the load. At least in instances, in which the aforementioned solution cannot be applied—e.g., because the lift axle is already lowered, because the overload occurs at a different wheel position or because no lift axle is installed in the motor vehicle—the safety system should initially issue a warning. In case of very slight overloads—up to approximately 2%—only a visual display is triggered. In case of more significant overloads, the driver should receive an acoustic warning in addition to the visual display—that, in comparison, is emotionally perceived as less annoying. In addition, the acoustic penetration preferably increases with higher overloads.

It is also useful to electronically limit the maximum speed of the motor vehicle beginning at an overload of approximately 5%, e.g., to 70 km/h beginning at an overload of 5%, to 60 km/h beginning at an overload of 10%, to 50 km/h beginning at an overload of 15%, to 30 km/h beginning at an overload of 20% and to 10 km/h beginning of an overload of 25%, with overloads in excess of 30% making it impossible to release the emergency brake such that the motor vehicle cannot even be driven.

The date regarding the pneumatic spring forces are preferably also utilized for performing other tasks. The driver, the loading party and the freight company desire additional information regarding the position of the actual center of gravity of the motor vehicle in the horizontal plane. In order to perform this additional task, all previously determined data regarding the spring forces are linked with one another in the ECU, namely in the fashion required for the equilibrium of the vertical forces and the torques generated therefrom. Based on the following diagram of forces for a vehicle with two axles and consequently 4 springs

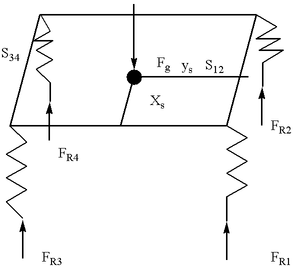

the equilibrium conditions are illustrated below:

ΣF=0=F_{R1}+F_{R2}+F_{R3}+F_{R4}−F_{g}

with

$${F}_{g} \cdot {y}_{s} = ( {F}_{R3} + {F}_{R4} ) \cdot l$$

$$\begin{matrix}\sum M = 0 = {x}_{s} \cdot {F}_{R3} - ( {s}_{12} - {x}_{s} ) \cdot {F}_{R4} + {F}_{R1} \cdot \\ ( {x}_{s} + \frac{{s}_{34} - {s}_{12}}{2} ) - {F}_{R2} \cdot ( {s}_{12} - {x}_{s} + \frac{{s}_{34} - {s}_{12}}{2} )\end{matrix}$$

$$results in$$

$${y}_{s} = \frac{( {F}_{R3} + {F}_{R4} ) \cdot l}{{F}_{R1} + {F}_{R2} + {F}_{R3} + {F}_{R4}}$$

$${x}_{s} = \frac{( {F}_{R2} + {F}_{R4} ) \cdot {s}_{12} + ( {F}_{R2} - {F}_{R1} ) \cdot \frac{{s}_{34}}{2} + ( {F}_{R1} - {F}_{R2} ) \cdot \frac{{s}_{12}}{2}}{{F}_{R1} + {F}_{R2} + {F}_{R3} + {F}_{R4}}$$

The spring gauge, ire., the axial distance between the center lines of the two springs of an axle, is identified by “S₁₂” on the front axle and by “S₃₄” on the rear axle. In the driving direction, the distance between the springs of one side of the motor vehicle is identified by “l” and is usually identical to the wheel base.

The thusly obtained information on the position of the center of gravity is preferably indicated on a display. In order to more easily comprehend the displayed position of the center of gravity, the motor vehicle contours and the wheels should be illustrated true to scale in the form of a top view with thin lines, with the actual center of gravity being displayed boldly—e.g., in red. The display preferably also indicates—in green—the most favorable position for the center of gravity, in which all wheels are subjected to an even load. The term “even load” refers to such a distribution of the individual wheel loads that the ratio between the actual wheel load and the maximum permissible wheel load is identical for each wheel.

The simultaneous display of the actual and optimal position of the center of gravity makes it possible to distribute the load in such a way that the actual center of gravity lies closer to the optimum. Consequently, the actual total weight of the motor vehicle may lie very close to the maximum permissible total weight of the motor vehicle, i.e., it is possible to transport more freight per trip while achieving the highest possible motor vehicle safety and the lowest possible wear.

If the empty weight and the position of its center of gravity are known—with the “empty weight” also including the fuel supply—the weight of the net load and the position of its center of gravity can be calculated by determining the total weight F_{g} of the motor vehicle and monitoring the position of its center of gravity (yₛ, xₛ). This may, in particular, be interesting for bookkeeping purposes.

Wheels containing twin tires are interpreted in the form of only one wheel in the context of this application.

### BRIEF DESCRIPTION OF DRAWINGS

The invention is described in greater detail below with reference to two embodiments that are respectively illustrated in three figures. Despite the fact that these two examples show the two types of constellations used most frequently within Europe today, the invention can also be applied to any other type of axle constellation. The figures show:

FIG. 1 is a schematic side view of a truck with a front axle that is suspended on leaf springs and a rear axle that is suspended on pneumatic springs;

FIG. 2 is a plan view of the same truck which is illustrated on the same scale, namely with the designations of the dimensions that need to be input into the computer as constant parameters;

FIGS. 3a and 3b represent the complete data flow chart for this first embodiment;

FIG. 4 is a schematic side view of an articulated road train with a two-axle semitrailer towing vehicle and a one axle semitrailer;

FIG. 5 is a plan view of the same articulated road train as that shown in FIG. 4 on the same scale, namely with the designations of the dimensions that need to be input into the computer as constant parameters, and

FIGS. 6a and 6b represents the complete data flow chart for this second embodiment.

### DETAILED DESCRIPTION OF THE INVENTION

The present invention will now be described in further detail in regard of the accompanying drawings.

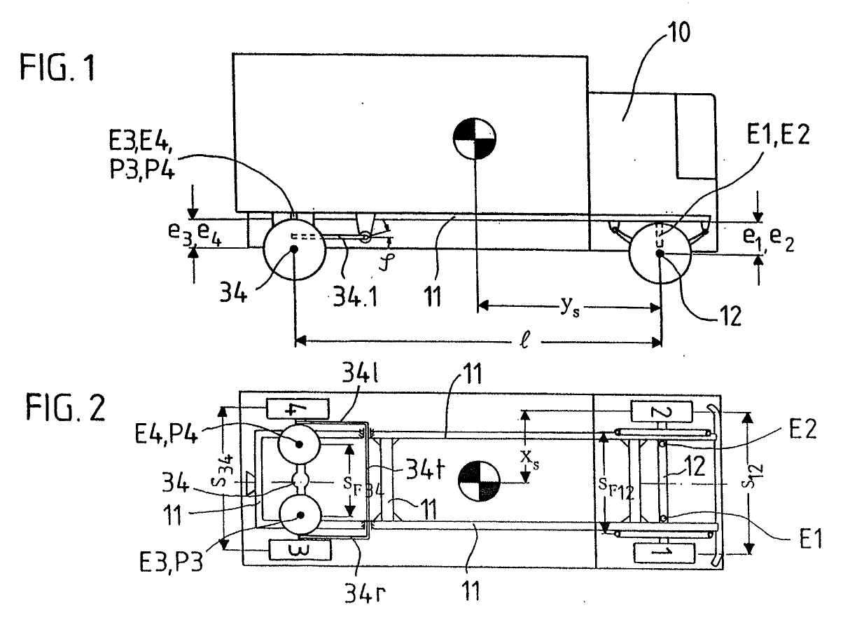

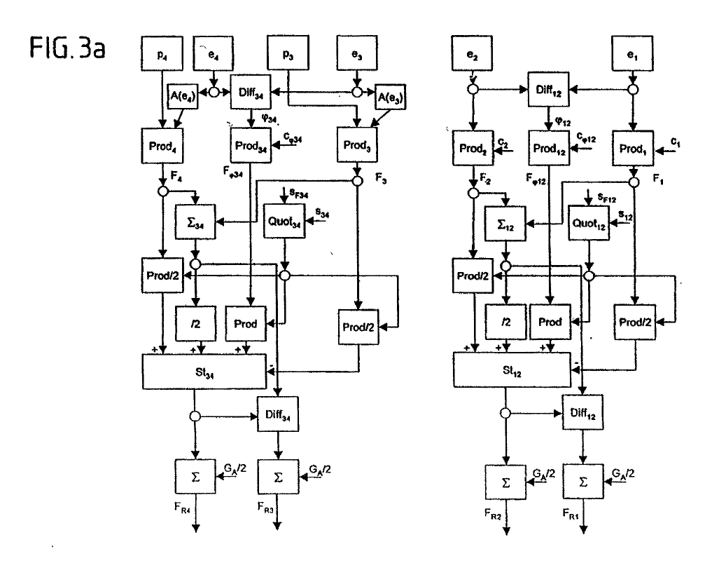

FIG. 1 shows a schematic side view of a truck 10 with a frame 11 consisting of welded I-bar steel profiles, a front axle 12 that is suspended on leaf springs and a rear axle 34 that is suspended on pneumatic springs. FIG. 2 which shows a plan view of the underside of the same truck indicates that two wheels 1 and 2 are arranged on the front axle 12. Analogously, the reference symbols 3 and 4 identify the wheels of the rear axle 34. The following description refers to FIGS. 1 and 2, both of which show illustrations on the same scale.

The rear axle 34 is, as is customary with axles suspended on pneumatic springs, provided with an anti-sway bar 34.1 and segmented into a left force introduction arm 34l, a right force introduction arm 34r and a torsion rod 34t arranged in between. In this embodiment, the two force introduction arms 34l and 34r also fulfill the function of guiding the wheels in order to eliminate the weight for separate longitudinal control arms.

The truck 10 is equipped with a total of 6 sensors, namely

the displacement sensor E1 for measuring the spring travel e₁ in the vicinity of the wheel 1,

the displacement sensor E2 for measuring the spring travel e₂ in the vicinity of the wheel 2,

the displacement sensor E3 for measuring the spring travel e₃ in the vicinity of the wheel 3,

the displacement sensor E4 for measuring the spring travel e₄ in the vicinity of the wheel 4,

the pressure sensor P3 for measuring the pneumatic spring pressure p₃ in the vicinity of the wheel 3, and

the pressure sensor P4 for measuring the pneumatic spring pressure p₄ in the vicinity of the wheel 4.

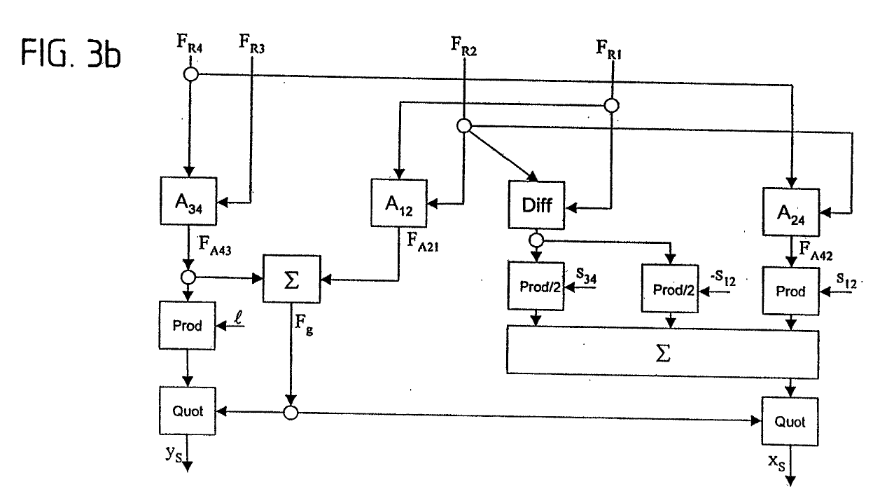

The torsion angle φ34 of the torsion rod 34t does not have to be separately measured, but is preferably determined from the difference between the two spring travels e₃ and e₄, as shown in the data flow chart according to FIG. 3.

In addition to the constant motor vehicle dimensions

l for the wheel base

S₁₂ for the wheel gauge of the front axle 12,

S₃₄ for the wheel gauge of the rear axle 34 (wherein the measurement is taken from the center between the two tires of the left wheel position to the center between the two tires of the right wheel position if the rear axle contains twin tires),

S_{F12} for the axial width between the two leaf springs of the front axle 12,

S_{F34} for the—axial—width between the two pneumatic springs of the rear axle 34, the stiffness c₁₂ for the stiffness of the leaf springs of the front axle 12, which is considered to be constant in this case over the spring travel for reasons of simplicity,

c_{φ34} for the stiffness of the anti-sway bar on the rear axle 34 and the particularly important function of the invention

A(e)₃₄ for the cross-sectional surface of the pneumatic springs of the rear axle 34, which is usually identical for both pneumatic springs of an axle and consequently also assumed as such in this case, the variable measuring values of the above-mentioned six sensors are input into the central computer ECU.

FIG. 3a shows the data flow chart in the ECU for this first embodiment, namely from the beginning; i.e., from the input of the variable data e₁, e₂, e₃, e₄, P₃ and P₄ which is illustrated in the first line, to the calculation of the four wheel forces F_{R1}-F_{R4}. FIG. 3b which could be attached to the bottom of FIG. 3a shows the additional data processing up to the calculation of the coordinates xₛ and yₛ of the center of gravity of the entire motor vehicle, i.e., including its net load. FIGS. 3a and 3b, both of which form parts of a coherent data flow chart, are described together below. In this description, an “o” refers to a data branch without other processing.

The right portion of FIG. 3a pertains to the front axle 12, with the left portion pertaining to the rear axle 34. The description initially refers to the right portion:

The two spring travels e₁ and e₂ are input into a differential element “Diff₁₂” that is shown in the second line of the diagram and delivers a signal that is proportional to the twisting of a possibly existing anti-sway bar. This signal is then input into the multiplier ″Prod₁₂ shown in the third line together with, if applicable, the spring constant cφ₁₂ for the stiffness of the possibly existing anti-sway bar on the front axle 12; if no anti-sway bar is provided on the axle 12, as is illustrated in FIGS. 1 and 2 in accordance with the frequently realistic conditions, a zero is input for cφ₁₂. Although the existence of the initially described differential element and the multiplier is inconsequential for this example, it is still desirable, namely with respect to the fact that this data processing device can be utilized independently of the existence of an anti-sway bar.

Originating at a branch point o, the actual spring travel e₁ is also input into a multiplier Prod₁ that contains the stored spring constant cl of the spring in the vicinity of the wheel 1 shown in FIG. 2 and multiplies both values with one another such that the spring force F₁ is obtained. Analogously, the actual spring travel e₂ is, originating at a branch point o placed after the initial input of e₂, input into a multiplier Prod₂ that contains the stored spring constant c₂ of the spring in the vicinity of the wheel 2 shown in FIG. 2 and multiplies both values with one another such that the spring force F₂ is obtained. Consequently, the forces F₁ and F₂ of the two axle springs as well as the force Fφ₁₂ of the possibly existing anti-sway bar are already present in the data output of the third line.

In the left portion, all three forces of the axles in question, i.e., the rear axle 34, also are already present at the data output of the third line. However, the processing is carried out somewhat differently because the axle 34 is suspended relative to the chassis by means of pneumatic springs instead of leaf springs. In a step that is carried out analogously to the right portion, the two spring travels e₃ and e₄ are input into a differential element “Diff₃₄” shown in the second line of the diagram and it delivers a signal that is proportional to the twisting of the existing anti-sway bar—43.1 in FIG. 2. This signal is then input into a multiplier “Prod₃₄” shown in the third line together with the constant cφ₃₄ for the stiffness of the anti-sway bar 34.1 on the rear axle 34.

Originating at a branch point o, the actual spring travel e₃ is also input into a functional interpreter A(e₃) that contains the stored function of the effective cross-sectional surface of the pneumatic spring in question depending on the spring travel e₃ and determines the effective cross-sectional surface A₃ from the spring travel e₃.

The thusly determined cross-sectional surface A₃ is then input into a multiplier Prod₃ together with a signal that is proportional to the pressure p₃ in the pneumatic spring in question, and =both values are multiplied with one another such that the spring force F₃ is obtained.

Analogously, the actual spring travel e₄ is, originating at a branch point o that is placed after the initial input of e₄, input into a functional interpreter A(e₄) that contains the stored function of the effective cross-sectional surface and determines the effective cross-sectional surface A₄ from the spring travel e₄.

The thusly determined cross-sectional surface A₄ is then input into a multiplier Prod₄ together with a signal that is proportional to the pressure p₄ in the pneumatic spring in question, and both valves are multiplied with one another such that the spring force F₄ is obtained.

Consequently, the forces F₃ and F₄ of both axle springs as well as the force Fφ₄₃ of the anti-sway bar 34.1 also are already present at the data output of the third line. In the following description, it is assumed for reasons of simplicity that, as is actually the case quite frequently, the anti-sway bar engages on the axle at the same location as the axle springs; however, if the width of the anti-sway bar deviates from the spring gauge, the corresponding ratio can be taken into consideration when inputting the spring stiffness Cφ₃₄.

From this point on up to the determination of the wheel forces F_{R1}, FR₂, FR₃, FR₄ on the lower edge of FIG. 3a, the data processing in the initially described right portion that pertains to the front axle 12 is carried out entirely analogously to the latter-described left portion that pertains to the rear axle 34. Consequently, only one portion is additionally described below; the right portion was selected at random for this description.

In order to calculate F_{R2} the data F₁ and F₂ are initially branched by means of a respective branch point o. One of these branch lines respectively extends into a summing element Σ₁₂ that forms the sum of F₁ plus F₂. This sum is then divided by 2 in an element “/2” such that the arithmetical mean of both spring forces is formed.

The additional terms to be taken into consideration when calculating F_{R2} also contain the ratio of the spring gauge divided by the wheel gauge, i.e., S_{F12}/S₁₂ on the right in this case. This ratio is referred to as the “width ratio” below. In order to determine the width ratio of the front axle, the two fixed motor vehicle dimensions S_{F12} and S₁₂ are input into a divider Quot₁₂.

In all operational elements that carry out a non-commutative computing operation, i.e., in Diff elements and Quot elements, the variable to be mentioned first in a corresponding equation, i.e., the minuend and the dividend, are drawn as being input from the top, with the second variable to be mentioned, i.e., the subtrahend and the divisor, being drawn as being laterally input into the operational element.

This width ratio is multiplied with F₂ and then divided by 2 in an element “Prod/2” that is arranged on the left (in the right portion). Analogous to the thusly determined term, the width ratio is multiplied with F₁ and then also divided by 2 in an additional element “Prod/2” that is arranged on the right.

The four terms determined so far are then linked by means of a line calculation operator “St₁₂” in such a way that the sum results from

1. the arithmetical mean (F₁+F₂)/2,

2. the width ratio times F₂/2,

3. the negative value of the width ratio times F₁/2 and

1. the width ratio times Fφ₁₂. This term linking results in a signal that describes the force on the wheel 2, however, without the dead weight of the axle 12. This signal is present at the branch point o between the last line and next to last line in FIG. 3a.

This signal is input into the differential element arranged on the right in the next to last line as the subtrahend, with F₁+F₂ being input as the minuend. Consequently, a signal which describes the force that engages on the wheel 1, namely without taking into consideration the dead weight of the axle 12, is present at the output of this differential element.

Half of the dead axle weight G_{A12} is added to both signals in one respective adding element—shown in the last line—whereafter the wheel forces F_{R1} and F_{R2} are determined. As described previously, the wheel forces FR₃ and FR₄ are determined in an entirely analogous fashion in the left portion; in this respect, the reference symbol “1” respectively needs to be replaced with “3” and the reference symbol “2” needs to be replaced with “4.” The data obtained so far already suffice for achieving the goal of the invention, namely to warn of an overload of individual wheels or for protecting individual wheels from being overloaded. For this purpose, the determined wheel forces F_{R1}, F_{R2}, FR₃ and FR₄ are compared to the maximum permissible wheel forces.

This data flow is continued in FIG. 3b. This portion serves for determining the coordinates xₛ and yₛ of the center of gravity and embodies the equations set forth herein above.

In this case, the signals for F_{R2} and F_{R4} are initially branched at a respective branch point “o.”

Three adding elements are arranged in the second line, namely

A₃₄ which forms the sum “F_{A43}” from the forces F_{R4} and F_{R3},

A ₁₂ which forms the sum “F_{A12}” from the forces F_{R2} and F_{R1} and

A₂₄ which forms the sum “F_{A42}” from the forces F_{R4} and F_{R2}.

The subtracting element “Diff” that determines the difference F_{R2} minus F_{R1} is also arranged in this line. This difference is branched once, with the left branch in a left element “Prod/2” initially being multiplied with the wheel gauge S₃₄ of the rear axle 34 and subsequently divided by 2, and with the right branch in a right element “Prod/2” initially being multiplied with the negative value of the wheel gauge s₁₂ of the front axle 12 and subsequently divided by 2. These two product halves are input into a summing element Σ that is shown on the bottom right, as is the product of the force sum F_{A42} and the wheel gauge s₁₂ of the front axle 12 which is determined in an element “Prod” that is arranged on the right in the middle vertically. The thusly determined sum signal is then input as the dividend into a division element “Quot” that is shown on the bottom right.

In order to determine the divisor, the force sums F_{A43} and F_{A21} are added to obtain the total weight F_{g} in an adding element Σ that is arranged on the left and this sum is branched once. The right branch thereof is input into the element “Quot” on the bottom right as the divisor and results in the coordinate xₛ of the center of gravity after the division is carried out.

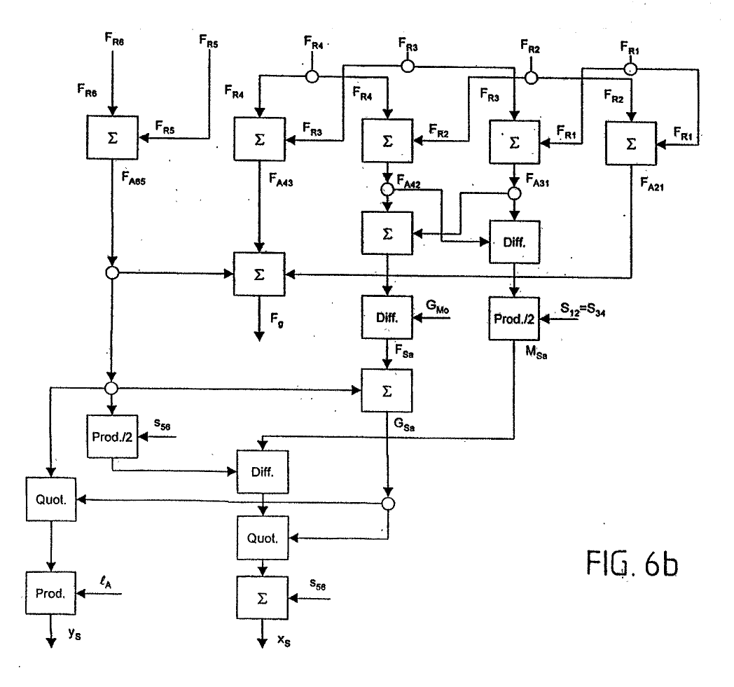

The force sum F_{A43} produced on the left is input into a left element “Prod” in the left branch after its branch point “o” and multiplied with the wheel base “l.” This product is input into a division element “Quot” that is arranged on the left as the dividend, namely together with the left branch of the signal F_{g} for the total weight as the divisor. This results in the longitudinal coordinate yₛ of the center of gravity.

Wherever the data lines intersect one another in the data flow charts shown in FIGS. 3a, 3b and 6a, 6b, the intersections are assumed to be non-conductive unless they are identified by the symbol “o” for a branch.

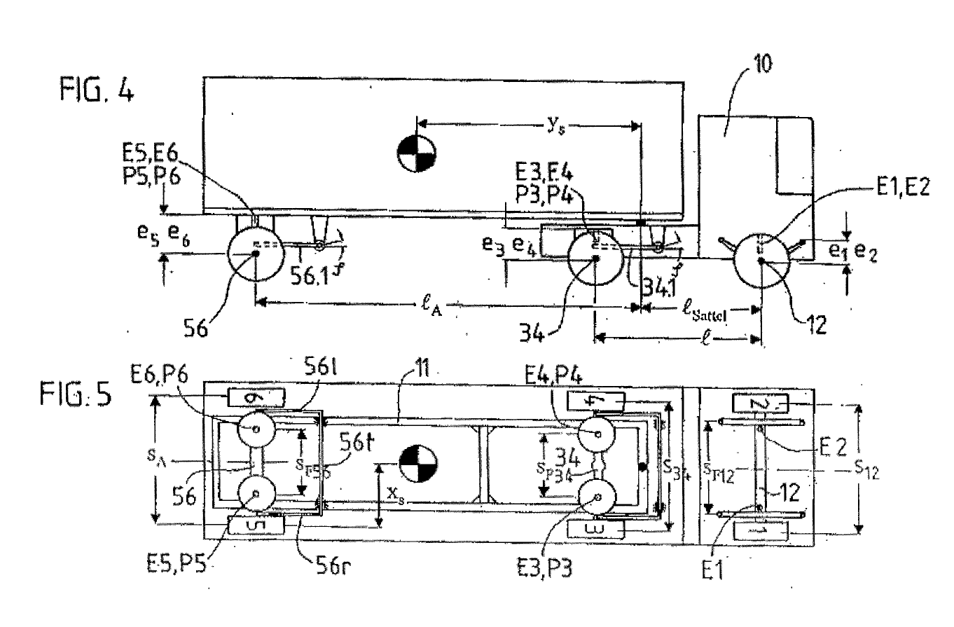

FIG. 4 shows a schematic side view of an articulated road train with a two-axle semitrailer towing vehicle 10 and a single-axle semitrailer 100. Although the semitrailer towing vehicle typically has a shorter wheel base l than a truck of the type shown in FIG. 1, the construction is, in principle, identical. This is the reason why the same reference symbols were used, e.g., 1 and 2 for the two front wheels and 3 and 4 for the two rear wheels. Consequently, the monitoring of the wheels and the determination of the center of gravity of the semitrailer towing vehicle can be carried out as described previously with reference to FIGS. 1, 2, 3a and 3b, and therefore, these processes are not described anew.

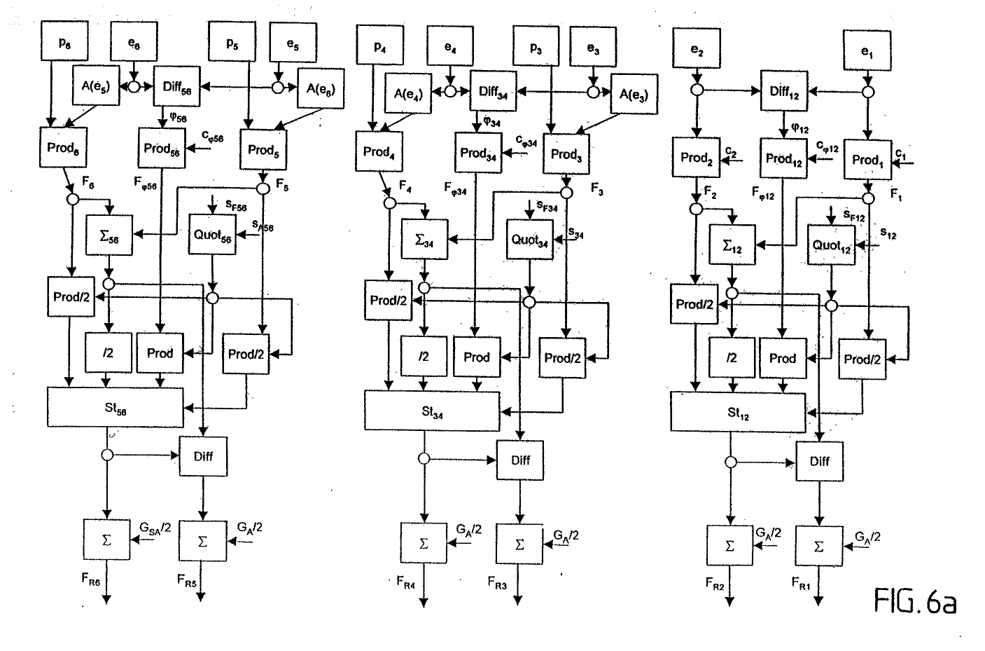

FIG. 4 and the related FIG. 5 primarily pertain to the monitoring of the semitrailer 100 and the termination of its center of gravity. FIG. 5 shows the same articulated road train as FIG. 4 in the form of a plan view on the same scale, namely including the designations of the dimensions that need to be input into the computer as constant parameters. The front axle of the semitrailer towing vehicle which is suspended on leaf springs and contains the wheels 1 and 2 is identified by the reference symbol 12, the rear axle of the semitrailer towing vehicle which contains the wheels 3 and 4 is identified by the reference symbol 34, and the axle of the semitrailer which contains the wheels 5 and 6 is identified by the reference symbol 56. FIGS. 4 and 5 are described together below.

Analogous to the rear axle 34 of the semitrailer towing vehicle 10, the axle 56 of the semitrailer 100 is suspended on pneumatic springs and equipped with an anti-sway bar 56.1, and is segmented into a left force introduction arm 56l, a right force introduction arm 56r and a torsion rod 56t arranged in between. In this embodiment, the two force introduction arms 56l and 56r also fulfill the function of guiding the wheels in order to eliminate the weight for separate longitudinal control arms.

The articulated road train 10 +100 is equipped with a total of 8 sensors, namely

the displacement sensor E1 for measuring the spring travel e₁ in the vicinity of the wheel 1,

the displacement sensor E2 for measuring the spring travel e₂ in the vicinity of the wheel 2,

the displacement sensor E3 for measuring the spring travel e₃ in the vicinity of the wheel 3,

the displacement sensor E4 for measuring the spring travel e₄ in the vicinity of the wheel 4,

the pressure sensor P3 for measuring the pneumatic spring pressure p₃ in the vicinity of the wheel 3,

the pressure sensor P4 for measuring the pneumatic spring pressure P₄ in the vicinity of the wheel 4,

the pressure sensor P5 for measuring the pneumatic spring pressure p₅ in the vicinity of the wheel 5, and

the pressure sensor P6 for measuring the pneumatic spring pressure p₆ in the vicinity of the wheel 6.

Neither the torsion angle φ56 of the torsion rod 56t nor the torsion angle φ34 of the torsion rod 34t need to be separately measured. These values are—as illustrated in the data flow chart according to FIG. 6a—determined from the difference between the two spring travels e₅, e₆ and e₃, e₄, respectively.

In FIG. 4, the wheel base of the semitrailer towing vehicle, i.e., the distance between the front axle 12 and the rear axle 34, is identified by the reference symbol “l” The wheel base of the semitrailer, i.e., the distance from the pivot of the fifth wheel to the trailing axle 56 of the semitrailer, is identified by the reference symbol “l_{A}.” The distance between the front axle 12 and the pivot of the fifth wheel is identified by the reference symbol “l_{Sattel}.” Since the pivot of the fifth wheel is not situated quite as far toward the front in most semitrailer towing vehicles, but rather placed almost exactly above the rear axle of the semitrailer towing vehicle, it is assumed that l_{Sattel}=l in the data flow chart of the relevant FIGS. 6a and 6b; this is the only option for maintaining the data flow chart sufficiently compact such that it could be illustrated on paper of the required format. In other respects, this slight deviation is relatively inconsequential in practical applications.

In addition to the constant motor vehicle dimensions

l for the wheel base of the semitrailer towing vehicle 10,

l^{A} for the wheel base of the semitrailer 100,

S₁₂ for the wheel gauge of the front axle 12 of the semitrailer towing vehicle 10,

S₃₄ for the wheel gauge of the rear axle 34 of the semitrailer towing vehicle 10 (wherein the measurement is taken from the middle between the two tires of the left wheel position to the center between the two tires of the right wheel position if the rear axle contains twin tires)

S₅₆ for the wheel gauge of the axle 56 of the semitrailer 100 that is—inconsequentially—identified by the reference symbol s_{A} at a few locations,

S_{F12} for the axial width between the two leaf springs of the front axle 12,

S_{F34} for the axial width between the two pneumatic springs of the rear axle 34,

S_{F56} for the axial width between the two pneumatic springs of the semitrailer axle 56, the stiffness c₁₂ for the stiffness of the leaf springs of the front axle 12 which is considered to be constant over the spring travel in this case for reasons of simplicity

cφ₅₆ for the stiffness of the anti-sway bar on the semitrailer axle 56, and the particularly important functions for the invention

A(e)₃₄ for the cross-sectional surface of the pneumatic springs of the rear axle 34, which usually is identical for both pneumatic springs of an axle and consequently also assumed as such in this case, and

A(e)₅₆ for the cross-sectional surface of the pneumatic springs of the semitrailer axle 56 which usually is identical for both pneumatic springs of an axle and consequently also assumed as such in this case,

the variable measuring values of the above-mentioned eight sensors are input into the central computer ECU.

FIG. 6a shows the data flow chart in the ECU for this second embodiment, namely from the beginning, i.e., from the input of the variable data e₁, e₂, e₃, e_{4,} e₅, e₆, p₃, p₄, p₅ and p₆ which is shown in the first line, up to the calculation of the six wheel forces F_{R1}-F_{R6}. FIG. 6b which could be attached to the bottom of FIG. 6a shows the additional processing of the data up to the calculation of the coordinates xₛ and yₛ of the center of gravity of the semitrailer including its net load. FIGS. 6a and 6b form parts of a coherent data flow chart. The reference symbols used correspond to those in FIGS. 3a and 3b, which eliminates a repetition of the corresponding description.

In order to provide a better overview, a simplification was necessary so as to be able to accommodate these figures on paper of the required format. This simplification consisted of the assumption that the wheel gauge of the axles 12 and 34 is identical. In instances, in which this simplification would lead to excessive inaccuracies, a person skilled in the art would be able to replace the corresponding portions of the data flow chart with those shown in FIGS. 3a and 3b.

In FIG. 6b, the reference symbol G_{Mo} refers to the weight of the semitrailer towing vehicle 10, the reference symbol M_{Sa} refers to the rolling moment about the longitudinal axis of the motor vehicle which is transmitted on the fifth wheel, and the reference symbol F_{Sa} refers to the vertical force transmitted on the fifth wheel.

Further variations and modifications of the foregoing will be apparent to those skilled in the art and are intended to be encompassed by the claims appended hereto.

German priority application 100 29 332.8 is relied on and incorporated herein by reference.

We claim:

1. A device for measuring the force transmitted by a pneumatic spring, comprising
a sensor for measuring the respective bellows pressure (p) arranged within the pneumatic spring,
one additional sensor (E) for measuring the spring travel (e) arranged in or in the vicinity of the pneumatic spring,
an electronic unit (ECU) for receiving
data regarding the bellows pressure (p) from said sensor and the spring travel e) from said additional sensor and storing a function which describes the effective cross-sectional surface (A of the pneumatic spring depending on spring travel (e) of the respective pneumatic spring, and for calculating the force transmitted by the pneumatic spring exclusively from these data.

2. A device for measuring the load status of a motor vehicle that is suspended on pneumatic springs and has at least 4 wheel positions that are distributed over at least 2 axles, with at least one axle being suspended on pneumatic springs comprising
a sensor (P) for determining the respective bellows pressure (p) within each pneumatic spring, one additional sensor (E) for measuring the spring travel (e) of each pneumatic spring, and an electronic control unit (ECU), for receiving
the data regarding the bellows pressure (p) from said sensor and the spring travel (e) from said additional sensor for each pneumatic spring for storing a function which describes the effective cross-sectional surface (A) of the pneumatic spring depending on the spring travel (e) of the pneumatic spring for each of the pneumatic springs of said vehicle,
and for calculating the transmitted spring force for each pneumatic spring exclusively from these data,
with the actual wheel load for each wheel position being calculated in the electronic control unit (ECU) from the data regarding all spring forces, by utilizing stored data by way of the spring gauges and axle gauges, and with warning means and/or means for activating another safety system in case an overload of one or more wheel positions is calculated.

3. The device according to claim 2, which is installed in a motor vehicle that is equipped with a lift axle, further comprising that that the device contains a safety system that lowers the lift axle when an overload of a wheel position in the vicinity of the lift axle is detected, such that the lift axle participates in carrying the load.

4. The device according to claim 2, wherein only a visual warning is issued when a very slight overload up to approximately 2% is calculated, with an acoustic warning signal being alternatively or additionally generated at higher overloads.

5. The device according to claim 4, wherein the penetration of the warning signal increases with higher overloads.

6. The device according to claim 2, wherein the attainable maximum speed of the motor vehicle, into which the device is installed, is electronically reduced if an overload of a wheel position in excess of approximately 5% is detected.

7. The device according to claim 2 further comprising means to block the emergency brake from being released if a severe overload of a wheel position is detected.

8. The device according to claim 6 further comprising means to block the emergency brake from being released if a severe overload of a wheel position is detected.

9. The device according to claim 2, further comprising means to link all data regarding the pneumatic spring forces which were determined in the electronic control unit (ECU) in order to calculate coordinates (xₛ, yₛ) of a center of gravity S of the motor vehicle in a horizontal plane.

10. The device according to claim 9 further comprising means to display the position of the actual center of gravity of the motor vehicle in relation to contours of the motor vehicle and/or its wheel positions on a display.

11. The device according to claim 9, further comprising means to display the distance and the direction which the actual center of gravity (S) needs to be displaced in order to reach the position of the center of gravity in which all wheel positions are subjected to an even load, such that the ratio between the actual wheel load and the maximum permissible wheel load is identical for each wheel position.

12. The device according to claim 2, installed in a motor vehicle, the maximum permissible total weight of which is lower than the sum of all maximum permissible wheel loads, and including means for calculating the sum of all actual wheel loads in the electronic control unit (ECU), means to compare this sum with the maximum permissible total weight of the motor vehicle stored therein and means to deliver at least a warning and/or activate another safety system when the maximum permissible total weight is exceeded.

13. The device according to claim 2, further comprising warning means for indicating the risk of overturning and/or activating means for activating another safety system if the position of the center of gravity (S) of the motor vehicle is situated at a significant distance from the longitudinal axis of the motor vehicle.

14. The device according to claim 13, which limits the maximum steering deflection depending on the motor vehicle speed to such a degree that an error on the part of the driver cannot cause the motor vehicle to overturn.

15. The device according to claim 9, further comprising warning means for indicating the risk of overturning and/or activating means for activating another safety system if the position of the center of gravity (S) of the motor vehicle is situated at a significant distance from the longitudinal axis of the motor vehicle.

16. The device according to claim 15, which limits the maximum steering deflection depending on the motor vehicle speed to such a degree that an error on the part of the driver cannot cause the motor vehicle to overturn.

17. The device according to claim 2, further comprising monitoring means to prevent the risk of overturning while driving, wherein the force of the left pneumatic spring is compared with the force of the right pneumatic spring or the wheel loads on the left side of the motor vehicle are compared with the wheel loads on the right side of the motor vehicle, and wherein the device delivers at least warning and/or activates another safety system when a certain threshold is exceeded through an electronic stabilizing system of the motor vehicle and/or its semitrailer towing vehicle or semitrailer which acts upon the brakes and/or the steering.

18. The device according to claim 9, further comprising monitoring means to prevent the risk of overturning while driving, wherein the force of the left pneumatic spring is compared with the force of the right pneumatic spring or the wheel loads on the left side of the motor vehicle are compared with the wheel loads on the right side of the motor vehicle, and wherein the device delivers at least warning and/or activates another safety system when a certain threshold is exceeded through an electronic stabilizing system of the motor vehicle and/or its semitrailer towing vehicle or semitrailer which acts upon the brakes and/or the steering.

19. The device according to claim 13, further comprising monitoring means to prevent the risk of overturning while driving, wherein the force of the left pneumatic spring is compared with the force of the right pneumatic spring or the wheel loads on the left side of the motor vehicle are compared with the wheel loads on the right side of the motor vehicle, and wherein the device delivers at least warning and/or activates another safety system when a certain threshold is exceeded through an electronic stabilizing system of the motor vehicle and/or its semitrailer towing vehicle or semitrailer which acts upon the brakes and/or the steering.

20. A method for measuring the force transmitted by a pneumatic spring having a bellows, comprising
measuring respective bellows pressure (p) within the pneumatic spring and obtaining pressure data, measuring spring travel (e) and obtaining spring travel data,
inputting said pressure data and said spring travel data into an electronic control unit (ECU),
said (ECU) having stored therein a function which describes the effective cross-sectional surface (A) of the pneumatic spring depending on the spring travel (e) of the respective pneumatic spring, and calculating the force transmitted by the pneumatic spring exclusively from these data.

21. A method for measuring the load status of a motor vehicle that is suspended on pneumatic springs and has at least 4 wheel positions that are distributed over at least 2 axles, with at least one axle being suspended on pneumatic springs comprising
determining the respective bellows pressure (p) within each pneumatic spring,
measuring the spring travel (e) of each pneumatic spring,
obtaining pressure data and spring travel data and inputting said data into an electronic control unit (ECU),
said (ECU) having stored therein a function which describes the effective cross-sectional surface (A) of the pneumatic spring depending on the spring travel (e) of the pneumatic spring for each of the pneumatic springs,
calculating the transmitted spring force for each pneumatic spring exclusively from these data,
with the actual wheel load for each wheel position being calculated in the electronic control unit (ECU) from the data regarding all spring forces, by utilizing stored data by way of the spring gauges and axle gauges, and
with the electronic control unit delivering at least one warning and/or activating another safety system in case an overload of one or more wheel positions is calculated.

22. The method according to claim 21, further comprising lowering a lift axle of said vehicle when an overload of a wheel position in the vicinity of the lift axle is detected, such that the lift axle participates in carrying the load.

23. The method according to claim 21, further comprising issuing a visual warning when a very slight overload is calculated, and generating an acoustic warning signal alternatively or additionally at higher overloads.

24. The method according to claim 21, further comprising electronically reducing the attainable maximum speed of the motor vehicle, into which the device is installed, if an overload of a wheel position in excess of approximately 5% is detected.

25. The method according to claim 21, further comprising blocking the emergency brake from being released if a severe overload of a wheel position is detected.

26. The method according to claim 21, further comprising linking all data regarding the pneumatic spring forces in the electronic control unit (ECU) and calculating coordinates (xₛ, yₛ) of the center of gravity S of the motor vehicle in a horizontal plane.

27. The method according to claim 26, further comprising displaying the position of the actual center of gravity of the motor vehicle in relation to the contours of the motor vehicle and/or its wheel positions on a display.

28. The method according to claim 21, further comprising calculating the sum of all actual wheel loads in the electronic control unit (ECU), comparing this sum with the maximum permissible total weight of the motor vehicle stored therein and delivering at least warning and/or activating another safety system when the maximum permissible total weight is exceeded.

29. The method according to claim 21, further comprising delivering a warning indicating the risk of overturning and/or activating another safety system if the position of the center of gravity (S) of the motor vehicle is situated at a significant distance from the longitudinal axis of the motor vehicle, and limiting the maximum steering deflection depending on the motor vehicle speed to such a degree that an error on the part of the driver cannot cause the motor vehicle to overturn.

30. The method according to claim 21, further comprising monitoring and/or preventing the risk of overturning while driving, wherein the force of the left pneumatic spring is compared with the force of the right pneumatic spring or the wheel loads on the left side of the motor vehicle are compared with the wheel loads on the right side of the motor vehicle, and delivering a visual or acoustical warning and/or activating another safety system when a certain threshold is exceeded through an electronic stabilizing system of the motor vehicle and/or its semitrailer towing vehicle or semitrailer which acts upon the brakes and/or the steering.
